(19) United States
(12) Patent Application Publication
(10) Pub. No.: US 2026/0264501 A1
(43) Pub. Date: Sep. 10, 2026

(54) DRIVE TRAIN FOR A MOTOR VEHICLE

(71) Applicant: ZF Friedrichshafen AG, Friedrichshafen (DE)

(72) Inventors: Hermann LANZ, Frickingen (DE); Horst LEICHSENRING, Meinheim (DE); Berthold SCHRAFF, Friedrichshafen (DE); Sylva ROTHER, Kressbronn am Bodensee (DE); Mario HOLDER, Tettnang (DE); Marco HENGGE, Bad Wurzach (DE)

(73) Assignee: ZF Friedrichshafen AG, Friedrichshafen (DE)

(21) Appl. No.: 19/541,963

(22) Filed: Feb. 17, 2026

(30) Foreign Application Priority Data
Feb. 17, 2025 (DE) 10 2025 105 752.4

(51) Int. Cl. B60K 6/387; B60K 6/26; B60K 6/405; B60R 16/02; B60R 16/023

(52) U.S. Cl. CPC B60K 6/387; B60K 6/26; B60K 6/405; B60R 16/0215; B60R 16/0231

(57) ABSTRACT

A drivetrain (2) for a motor vehicle (1) has a transmission module (7), a clutch module (8), and a further module (3) arranged spatially between the transmission module (7) and the clutch module (8). The transmission module (7) includes a transmission control unit (24) and the clutch module (8) includes a separator clutch (23) for the drive coupling and decoupling of an internal combustion engine (9) to or from the transmission module (7), as well as a sensor (25). At least in a housing component of the further module (3), a first cable routing duct (10a) is provided for the passage of at least one electric lead (14) which connects the sensor (25) to the transmission control unit (24). The first cable routing duct (10a) extends spatially separately from an inside space (5) of the further module (3).

### RELATED APPLICATIONS

This application claims the benefit of and right of priority under 35 U.S.C. § 119 to German Patent Application no. 10 2025 105 752.4, filed on 17 Feb. 2026, the contents of which are incorporated herein by reference in its entirety.

### FIELD OF THE DISCLOSURE

The invention relates to a drivetrain for a motor vehicle. In addition, the invention relates to a motor vehicle with such a drivetrain and to a hybrid module for a drivetrain of a motor vehicle.

### BACKGROUND

From DE 10 2021 208 817 A1 a housing body for a hybrid drivetrain is known, which is designed to produce a hybrid module, with a radially internal bearing area designed to accommodate a shaft bearing for an input shaft of the hybrid module, and with a shield area adjoining the bearing area and extending in the radial direction of the housing body. Adjoining the shield area a receiving area that extends in the axial direction of the housing body is provided, the receiving area being designed to accommodate an electric machine of the hybrid module. The shield area has a ribbed structure with a plurality of radial ribs which, starting from the bearing area, extend radially in the direction of the receiving area.

In a standard drivetrain of a motor vehicle, a clutch actuator is located inside the clutch bell axially directly on the transmission or the transmission module. The electronic control of the clutch actuator in this case can be realized with a simple cable guide and plug arrangement directly between the transmission control unit provided on the transmission module and the clutch actuator, in particular a path sensor arranged on it. However, if an additional module, such as a hybrid module or a motor-dependent auxiliary drive, is arranged ahead of the existing clutch bell of a clutch module, then the direct connection option of the transmission control unit to the clutch actuator of the clutch module is no longer possible.

### SUMMARY

The purpose of the present invention is to propose a simply constructed and compact drivetrain for a motor vehicle, which if at least one additional aggregate is provided between a clutch module and a transmission module, enables secure and sealed cable routing between the clutch actuator of the clutch module and a transmission control unit arranged in the drivetrain. A further purpose of the present invention is to propose a hybrid module which enables secure and sealed cable routing between a drive input side and a drive output side of the hybrid module.

These objectives are achieved by a drivetrain having the features specified in a first aspect of the invention, by a motor vehicle with the features specified in a second aspect of the invention, and by a hybrid module with the features specified in a third aspect of the invention. Further advantageous embodiments emerge from the dependent claims.

A proposed drivetrain for a motor vehicle comprises a transmission module and a clutch module and a further module arranged spatially between the transmission module and the clutch module. The transmission module has a transmission control unit. In particular, this is arranged on or in the transmission module. The clutch module has a separator clutch for coupling and decoupling an internal combustion engine drivingly to the drivetrain, and a sensor. Thus, the internal combustion engine optionally can be drivingly coupled to the drivetrain or decoupled therefrom. In this case, it is also provided that at least in a housing component of the further module a first cable routing duct for running at least one electric lead is provided, which extends spatially separated from an inside space of the further module. The electric lead connects the sensor to the transmission control unit.

In other words, an electric lead integrated in the housing of the further module or hybrid module extends by way of at least one cable routing duct that is essentially axially orientated to the transmission control unit, without the lead passing directly through the inside space of the module. Thus, the cable routing duct serves as a bypass passage for the electric lead to run from a drive input zone on the clutch side of the further module to a drive output zone on the transmission side of the further module, in the inside space of the further module.

The cable routing duct preferably extends through the housing component of the further module, for example in the form of a bore, a tube, a duct, and/or a cut-out. The cable routing duct can be produced, for example, during a casting process of the housing component or inlaid therein. Particularly preferably, the cable routing duct is integrated in a wall of the further module. In particular, the cable routing duct is thus part of the wall, for example it can be cast into the wall during a casting process or else machined into the wall.

The advantage of diverting the electric lead within the inside space of the housing portion but bypassing the inside space of the further module is that the electric lead does not have to be additionally secured or sealed. Rather, by routing it through the passage provided it is already protected from outside influences, such as oil, dirt, and liquids, by the housing component. A further advantage of such cable routing is that no further external leads with costly and elaborate sealing concepts and the like have to be fitted. Instead, simple and/or inexpensive sealing measures are already sufficient for running the electric lead even over a larger distance between the sensor and the transmission control unit, regardless of the number of further modules arranged between the clutch module and the transmission module.

The sensor preferably serves to detect a condition of the separator clutch, in particular such as the switched condition of the separator clutch. The sensor is in particular part of the clutch module. Preferably, the sensor is a path sensor arranged directly on the clutch release mechanism of the clutch module for detecting an axial position of the clutch release element. In that way the switched condition of the separator clutch can be monitored, so enabling the separator clutch to be actuated precisely. In particular, the electric lead constitutes a signal-carrying connection between the sensor and the transmission control unit. It can be provided that by way of the electric lead, the clutch module and/or the cable routing duct is/are also supplied with energy for actuating the separator clutch. Alternatively, it can be provided that via the electric lead and/or the cable routing duct, exclusively a signal-carrying connection between the sensor and the transmission control unit is formed. The energy for actuating the separator clutch is then supplied to the clutch module in some other way.

In particular, the transmission module has a number of optionally engaged gear ratio steps. The transmission control unit serves specifically to engage the gear ratio steps and to actuate the clutch module, i.e., to open and close the separator clutch.

Preferably, the further module comprises a clutch bell as a housing component, which is designed for the spatial accommodation at least of a clutch release mechanism of the separator clutch. In this case, the first cable routing duct can be arranged in the clutch bell and/or it can open into the clutch bell. In particular the clutch bell realizes a spatial separation between the further module and the clutch module. The clutch bell can have openings to allow the passage of components, in particular a shaft, between the clutch module and the further module.

Alternatively, or in addition, the further module comprises a cover element as its (second) housing component, such that in the cover element a further (second) cable routing duct for the passage at least of the electric lead is provided. In particular, the cover element realizes a spatial separation between the further module and the transmission module. The cover element can be screwed to the clutch bell on one side (the drive input side). The cover element can be screwed to a transmission housing of the transmission module on the other side (the drive output side). In turn, the clutch bell can be connected to a housing of the clutch module.

The cable routing ducts, when more than one is provided, are connected to one another at a (first) interface between the clutch bell and the cover element for the passage of the at least one electric lead. Preferably, a (first) seal is arranged at the (first) interface between the first and second cable routing ducts, which seals the interface. Accordingly, housing separation points, for example by different housing components, are bridged within the further module by suitable seals. In particular, the (first) seal prevents coolant and/or lubricant or other undesired fluids or solid bodies from being able to penetrate into the cable routing ducts by way of the interface, from the inside space of the further module and from an external environment of the further module. A simple structure of the (first) seal is an O-ring, although of course other seal variants are also possible. Thus, in particular, the first cable routing duct and the second cable routing duct are directly connected with one another and together form a passage for the electric lead through the further module.

The inside space of the further module is in particular that space of the further module which is provided specifically for the accommodation of drive-input-relevant components, in such manner that the components can be lubricated and/or cooled within the inside space. Preferably, an electric machine for powering the drivetrain is arranged in the inside space. The inside space is in particular defined by the shape of the housing component and the cover element. Thus, these delimit the inside space relative to an external environment of the further module.

Preferably, the first cable routing duct is in the clutch bell, and the second cable routing duct is arranged coaxially with it in the cover element. Expressed otherwise, the first and second cable routing ducts are arranged aligned with one another, i.e., axially one behind the other.

The further module is in particular an additional aggregate of the drivetrain, which can be designed as required to suit the drivetrain and the motor vehicle containing the drivetrain. The drivetrain is a modular configuration wherein the individual modules can comprise interfaces for receiving other modules. The interfaces are so designed that different modules can be combined with one another.

Preferably, the further module is a hybrid module comprising an electric machine. The electric machine, in particular a rotor shaft of the electric machine, is connected at least indirectly to an input of a transmission of the transmission module. The electric machine can be supplied with electrical energy by way of a power terminal which is preferably arranged on the housing of the hybrid module. The electric machine is spatially arranged inside the housing of the hybrid module formed by the clutch bell and the cover element, and the cable routing duct concerned is arranged spatially separate from the inside space, in which a rotor and a stator of the electric machine are located and supplied with coolant or lubricant. In that sense the inside space of the further module is spatially delimited at least by a shield area of the clutch bell and the cover element of the further module. The cable routing duct concerned extends in the axial direction of the hybrid module, radially outside the inside space of the hybrid module.

The shield area is a section of the clutch bell that extends essentially radially. The cover element of the further module can be of cup-shaped design. The clutch bell can have a receiving area which adjoins the shield area and extends in the axial direction, which can be designed for the at least partial accommodation of the electric machine of the hybrid module. The shield area and the receiving area are preferably made integrally, in particular in the form of a casting.

The electric machine is in particular designed to power the drivetrain. In other words, the hybrid module is an additional drive-power source for the drivetrain, besides the aforesaid internal combustion engine, which the latter can be coupled or decoupled to or from the transmission module by way of the separator clutch. Thus, the drivetrain can optionally be driven by the internal combustion engine and/or the electric machine. Alternatively, it is possible for the further module to be in the form of a motor-dependent auxiliary drive module or a torque converter clutch. Likewise, other possible uses for the further module are conceivable.

Furthermore, it is possible for a second cable routing duct to be provided in the transmission housing of the transmission module, which is connected at a second interface between the cover element of the further module and the transmission housing to the first cable routing duct for the passage of the at least one electric lead. Correspondingly, a further seal can be provided at the second interface.

Inasmuch as elements, in particular cable routing ducts, are identified with the help of numbering, i.e., for example “first cable routing duct”, “second cable routing duct” and “further cable routing duct”, this numbering is provided solely for the purpose of differentiating the identifications and does not represent any dependence of the elements relative to one another or any necessary sequencing of the elements. In particular, this means that a drivetrain does not have to have a “first cable routing duct” in order to be able to have a “second cable routing duct”. Moreover, the drivetrain can have a “first cable routing duct” and a “third cable routing duct” but without necessarily having a “second cable routing duct”.

According to a second aspect, the invention also relates to a motor vehicle which comprises a drivetrain according to the above descriptions. The motor vehicle can have one or more such drivetrains. It is also possible that the drivetrain comprises a differential gear system or is connected to a differential gear system on an axle of the motor vehicle, in order to divide a drive power of the drivetrain between drive wheels of the axle concerned.

According to a third aspect, the invention also relates to a hybrid module, or the aforesaid hybrid module, for a drivetrain of a motor vehicle. In this case the hybrid module comprises an electric machine, or the aforesaid electric machine, for powering the drivetrain, and a housing component, or the aforesaid housing component, for accommodating the electric machine, specifically in an inside space, or the aforesaid inside space of the housing component. A drive output side of the hybrid module is designed for the attachment of a transmission module, or the aforesaid transmission module, to the hybrid module. A drive input side of the hybrid module is designed for the attachment of a clutch module, or the aforesaid clutch module, to the hybrid module. In this case, in particular the clutch module comprises a separator clutch, or the aforesaid separator clutch, for the driving coupling and decoupling of an internal combustion engine, or the aforesaid internal combustion engine, to or from the drivetrain, and preferably also a sensor, or the aforesaid sensor. In addition, it is provided that in the housing component of the hybrid module a cable routing duct, or the aforesaid cable routing duct, extends for the passage of at least one lead running between the drive input side and the drive output side of the hybrid module. In this case the cable routing duct extends spatially separated from the inside space of the hybrid module. The lead is in particular an electric lead, or the aforesaid electric lead.

Both on the drive input side and on the drive output side of the hybrid module, the cable routing duct has in particular respective openings through which the lead can be introduced into the cable routing duct.

The above definitions and descriptions of technical effects, advantages and advantageous embodiments of the drivetrain of the invention according to the first aspect of the invention also apply analogously to the motor vehicle of the invention according to the second aspect of the invention and to the hybrid module of the invention according to the third aspect of the invention, and conversely in each case. In other words, the features and explanations pertaining to the further module are also applicable to the drivetrain and to the hybrid module.

### BRIEF DESCRIPTION OF THE DRAWINGS

Below, example embodiments of the invention are explained in greater detail with reference to the figures, which show:

FIG. 1: A schematic view from above, of a motor vehicle comprising a drivetrain according to a preferred embodiment,

FIG. 2: A perspective sectioned representation through a hybrid module of the drivetrain shown in FIG. 1, arranged on a clutch module, and

FIG. 3: A schematic longitudinal sectioned view of the hybrid module of the drivetrain according to FIGS. 1 and 2.

### DETAILED DESCRIPTION

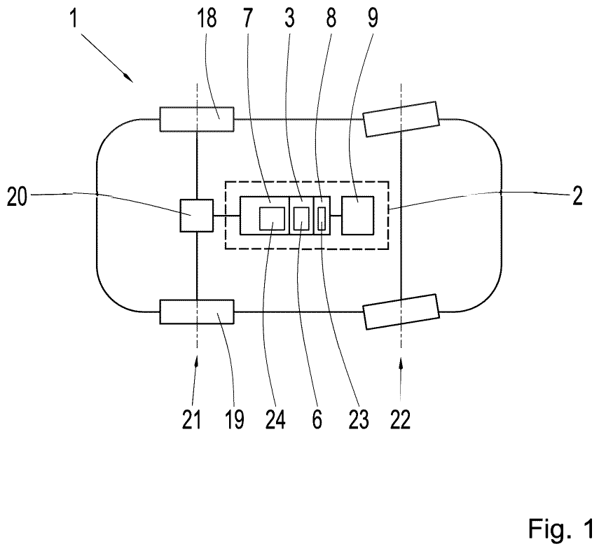

FIG. 1 shows, very schematically, a motor vehicle I seen from above. The motor vehicle 1 has a first axle 21 as its rear axle and a steered second axle 22 as its front axle, the first axle 21 comprising a drivetrain 2 which is functionally connected to a differential 20. The differential 20 divides a drive power of the drivetrain, i.e. a rotation speed and a torque, between two wheels 18, 19 of the first axle 21.

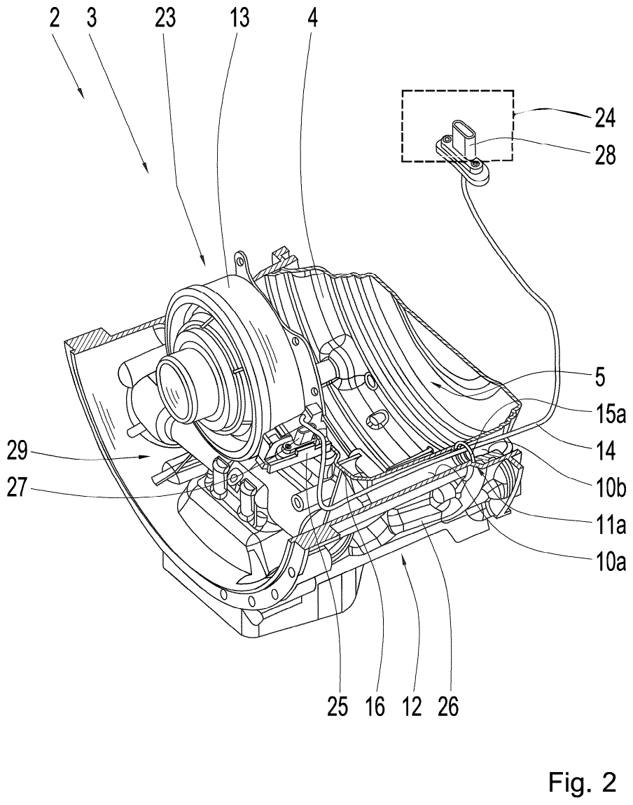

The drivetrain 2 is constructed in a modular manner, with modules arranged axially one after another. According to FIG. 1 the drivetrain 2 shown as an example comprises a transmission module 7, a clutch module 8 with a separator clutch 23 for optionally coupling and decoupling an internal combustion engine to or from the transmission module, depending on the operating condition at the time, and a sensor 25, for example in the form of a path sensor, for detecting the position of the clutch release mechanism 13—see also FIG. 2. Thus, the internal combustion engine can be used as a source of drive power for the drivetrain 2.

With the sensor 25 the switching condition of the separator clutch 23 can be determined. The sensor 25 is arranged on the clutch release mechanism 13. By way of an electric lead 14 the sensor 25 transmits signals and/or information to a transmission control unit 24 arranged in or on the transmission module 7. Preferably, the sensor 25 too is supplied with electrical energy by way of the electric lead 14. The electric lead 14 is connected to the sensor 25 by means of a first plug connector. At its opposite end the electric lead 14 is connected to the transmission control unit 24 by a second plug connector 28.

Spatially between the transmission module 7 and the clutch module 8 is arranged a further module 3, which in this case is preferably in the form of a hybrid module. The further module 3 has a drive input side associated with the clutch module 8 and a drive output side associated with the transmission module 7. The further module 3 contains an electric machine 6 which can be used as a further source of drive power for the drivetrain 2. In that way the drive power of the internal combustion engine 9 can be dispensed with at least some of the time and/or the internal combustion engine can be supported with electric motor power. In addition, the electric machine 6 can be operated as a generator. For greater simplicity, the electric machine 6 is not shown in FIG. 2. It is preferably arranged in the inside space 5, which can be seen clearly in FIG. 2.

The further module 3 has a housing component which forms a clutch bell 12, and a cover element 4. These spatially delimit an inside space 5 with the electric machine 6 arranged in it and separate the inside space 5 from external surroundings. The clutch bell 12 comprises the inner area 29. Then, the clutch bell 12 preferably accommodates the separator clutch 23 and the clutch release mechanism 13 of the clutch module 8 on the drive input side of the hybrid module 3.

The inside space 5 of the module 3 is spatially delimited by a shield area 16 of the clutch bell 12 and by the cover element 4 of the further module 3 on the transmission side. The clutch bell 12 is designed such that at least part of the clutch release mechanism 13 of the separator clutch 23 is accommodated by it. The separator clutch 23 is connected on the drive input side of the module 3. The separator clutch 23 is for example a single-disk dry clutch.

On the drive output side of the further module 3 the transmission module 7 can be connected to the further module 3, particularly in the area of a clutch bell of the transmission module 7.

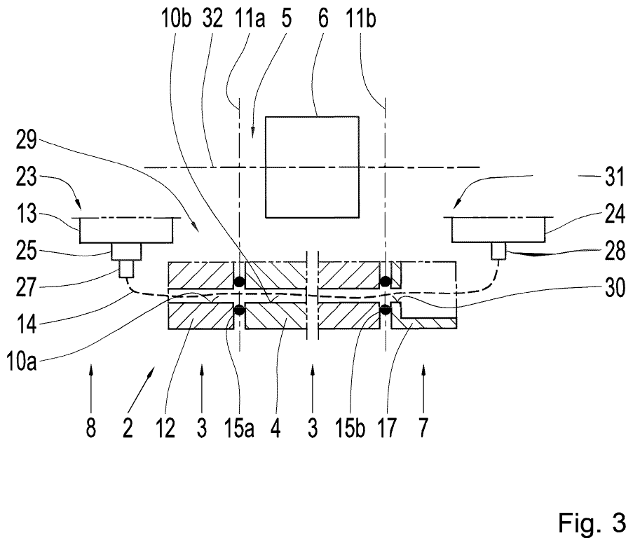

According to FIGS. 2 and 3, a first cable routing duct 10a is provided in the clutch bell 12 of the module 3, and a second cable routing duct 10b is provided in the cover element 4 of the further module 3, to create a passage for the electric lead 14 between the inner area 29 of the clutch bell 12 and a transmission control unit 24 of the transmission module 7. The transmission control unit 24 is for example located in an inside space 31 of the transmission module 7 spatially delimited by a transmission housing 17. Alternatively, the transmission control unit 24 can also be arranged on the outside of the transmission module 7, or somewhere else in the motor vehicle 1.

The cable routing ducts 10a and 10b are arranged coaxially with one another and extend parallel to a rotation axis 32 of the electric machine 6. They are located spatially outside the inside space 5 in which the electric machine 6 is located. Together, the cable routing ducts form a passage for the electric lead 14 between the drive input side and the drive output side of the further module 3. Thus, the electric lead 14 runs within the cable routing ducts 10a, 10b between the drive input side and the drive output side of the further module 3.

The diameter of the cable routing ducts 10a, 10b is preferably chosen such that the electric lead 14 can be threaded through them. It is possible that in addition to the electric lead 14, further leads as well are routed through the cable routing ducts 10, 10b and therefore run between the drive input side and the drive output side of the further module 3, such as a compressed-air line and/or an oil line. However, it is also possible that the cable routing ducts 10a, 10b are provided exclusively for the passage of the electric lead 14 of the sensor 25.

To seal the cable routing ducts 10a, 10b a first seal 15a is provided between the clutch bell 12 and the cover element 4, and a second seal 15b is provided between the cover element 4 and a transmission housing 17 of the transmission module 7, in each case in the form of an O-ring. The first seal 15a is provided at a first interface 11a between the clutch bell 12 and the cover element 4, whereas the second seal 15b is provided at a second interface 11b between the cover element 4 and the transmission housing 17. Here, the interfaces 11a, 11b are represented simply as dot-dash lines. In this case the transmission housing 17 has an aperture 30 arranged in line with the two cable routing ducts 10a, 10b. By virtue of this sealing and the configuration of the cable routing ducts 10a, 10b, the passage formed thereby through the further module 3 is separated relative to both the inside space 5 and the external surroundings of the further module 3.

In the circumferential direction the cable routing ducts 10a, 10b are in particular arranged between screw connections—not shown here—for connecting the clutch bell 12 to the cover element 4 and/or between screw connections—not shown here—for connecting the cover element 4 to the transmission housing 17.

As shown in FIGS. 2 and 3, the passage formed through the cable routing ducts 10a, 10b extends within walls of the housing of the further module 3. In this case the ducts 10a, 10b form an integral part of the walls. For that purpose, each cable routing duct 10a, 10b is embedded in the wall, for example in that the respective duct 10a, 10b is already cast in place during the casting process used to produce the housing component concerned. Alternatively, it is possible for each duct 10a, 10b to be incorporated in the housing component, for example in the form of a bore. It is also possible for one, some or all of the ducts 10a, 10b to be in the form of a tube inserted into the housing. The essential point here is that the passage provided in the further module 3 in whatever way, which extends between the drive input side and the drive output side of the module 3, is spatially separated from the inside space 5 of the module 3.

### INDEXES

1 Motor vehicle
2 Drivetrain
3 Further module, hybrid module
4 Cover element
5 Inside space of the further module
6 Electric machine
7 Transmission module
8 Clutch module
9 Internal combustion engine
10a Cable routing duct
10b Cable routing duct
11a Interface
11b Interface
12 Clutch bell
13 Clutch release mechanism
14 Electric lead
15a Seal
15b Seal
16 Shield area
17 Transmission housing
18 Wheel
19 Wheel
20 Differential gear system
21 Axle
22 Axle
23 Separator clutch
24 Transmission control unit
25 Sensor
26 Receiving area
27 Plug connector
28 Plug connector
29 Inner area of the clutch bell
30 Aperture
31 Inside space of the transmission module
32 Rotation axis

1. A drivetrain (2) for a motor vehicle (1), comprising:
a transmission module (7) having a transmission control unit (24);
a clutch module (8); and-with
a further module (3) arranged spatially between the transmission module (7) and the clutch module (8), the further module (3) having a housing component;
wherein the clutch module (8) comprises
a separator clutch (23) configured for drive coupling and decoupling of an internal combustion engine (9), and
a sensor (25),
wherein at least in the housing component of the further module (3) a first cable routing duct (10a) is provided for the passage of at least one electric lead (14) connecting the sensor (25) to the transmission control unit (24), and wherein the first cable routing duct (10a) extends spatially separately from an inside space (5) of the further module (3).

2. The drive-train (2) according to claim 1, wherein the housing component comprises a clutch bell (12) configured to accommodate spatially at least a clutch release mechanism (13) of the separator clutch (23), and wherein the first cable routing duct (10a) is arranged in the clutch bell (12) and/or opens into the clutch bell (12).

3. The drivetrain (2) according to claim 2, wherein the housing component comprises a cover element (4) defining a second cable routing duct (10b) for the passage at least of the electric lead (14).

4. The drivetrain according to claim 3, wherein the first cable routing duct (10a) and the second cable routing duct (10b) are connected directly to one another and together form a cable routing passage for the electric lead (14) through the further module (3).

5. The drivetrain (2) according to claim 4, wherein the first cable routing duct (10a) and the second cable routing duct (10b) are arranged coaxially with one another.

6. The drivetrain (2) according to claim 4, comprising a seal (15) arranged at an interface (11) between the first and second cable routing ducts (10a, 10b).

7. The drivetrain (2) according to claim 3, wherein the further module (3) is a hybrid module with an electric machine (6) for powering the drivetrain (2).

8. The drivetrain (2) according to claim 7, wherein the inside space (5) of the further module (3), which accommodates the electric machine (6), is spatially delimited by a shield area (16) of the clutch bell (12) and the cover element (4).

9. A motor vehicle comprising the drivetrain (2) according to claim 1.

10. A hybrid module (3) for a drivetrain (2) of a motor vehicle (1), comprising:
an electric machine (6) for powering the drivetrain (2); and
a housing component for accommodating the electric machine (6);
wherein a drive output side of the hybrid module (3) is configured for connection to a transmission module (7); and
wherein a drive input side of the hybrid module (3) is configured for connection to a clutch module (8) which serves for the drive coupling and decoupling of an internal combustion engine (9); and
wherein in the housing component of the hybrid module (3) a cable routing duct (10a) is provided for the passage of at least one lead (14), which runs between the drive input side and the drive output side, and the cable routing duct (10a) extends spatially separately from an inside space (5) of the hybrid module (3).
